(19) United States
(12) Patent Application Publication
(10) Pub. No.: US 2003/0132153 A1
(43) Pub. Date: Jul. 17, 2003

(54) Filter cartridge covering

(76) Inventor: Feffrey Alan Jelten, Capitola, CA (US)

Correspondence Address: Jeff A. Jelten, 540 NW 9th Street, Corvallis, OR, 97330, US

(21) Appl. No.: 10/045,361

(22) Filed: Jan. 15, 2002

(51) Int. Cl. B01D 29/58

(52) U.S. Cl. 210/232; 210/484; 210/489; 210/501; 210/502.1; 210/315; 210/342; 210/496; 210/499

(57) ABSTRACT

A sleeve or wrap that fits over a cartridge type filter whereby enhancing the effectiveness of that filter. A preferred embodiment of the invention is to fabricate this sleeve or wrap using the category of material commonly referred to as “nonwoven” taking advantage of one or more of the functional properties possible with the composition of this material such as the ability to capture large debris, filter out chemical elements, absorb oils and many other advantages beneficial to the filtering process. This sleeve or wrap may be fabricated as a one piece tube that slides snugly over the filter. Supplied as a blanket or wrap with a thin strip of hook material along one edge similar to that used in a “Velcro tm” hook and loop fastening system and with the nonwoven material of the wrap acting as the loop so the wrap may be fit snugly over a broad range of diameter filters. Another possible embodiment is to manufacture a tube or cylinder of a diameter calculated to be larger than the filter and with a rigid strip fastened horizontally to the cylinder which will facilitate easy placement over the filter then twisting the rigid strip effectively places a fold in the cylinder reducing the diameter to fit snugly around the filter. This sleeve, being porous may be slipped over the filter while in place and with the pump drawing water through it so as to trap the accumulation on the filter making it possible to remove the filter for cleaning without loosing any accumulation back into the body of water being filtered.

### BACKGROUND

This invention relates to the cartridge type filter, which is becoming the most common filtration media in the world. Though this filter does a good job of stopping a large percent of the particulate, the concept is limited to particles of a certain size range. If the filtration media is too fine it quickly cakes up on the up stream side causing increase in flow pressure which then requires more frequent service of filter. Large particles, debris and worst of all hair are stopped by the filter but often slough off and fall to the bottom of the filter reservoir and can be sucked back into the system. This problem is exacerbated when the filter cartridge is serviced. As soon as suction through the filter is discontinued some of the large debris and build up drops off, additionally, when the reservoir is drained to access the cartridge for servicing, buildup is pulled off and even flushed out by water pouring out of the pleats as the water level drops. Some systems , such as those common in spas or hot tubs, require the filter to be disengaged then removed directly from the reservoir of water further accentuating the flushing out of buildup into the water being filtered.

This problem has been recognized and attempts have been made to address the issue primarily through the re-engineering of the reservoir of the system. This usually involves complicated plumbing arrangements which allow for valves to channel off buildup and even effectively back flush the filter cartridge in the reservoir. This method may be applicable for some systems but is not practical for the majority of situations and is prohibitively expensive to retro fit to most existing systems.

Other inventions have addressed the issues by manufacturing a filter cartridge out of layers of nonwoven matting of varying density and composition. While this composition does increase the filtering efficiency, the same characteristics that make them functional make them difficult or even impossible to thoroughly clean, complicating the servicing of the filter to the degree that it has proven undesirable.

Accordingly this invention allows for an addition to existing filter cartridges which will greatly increase the efficiency and functionality of the cartridge type filter. This is accomplished through the addition of a sleeve or wrap of a plastic or synthetic filter media commonly referred to as a “nonwoven”. This material has the advantage of allowing high flow through while snagging any of the large debris, allowing the finer filter elements or pleats to filter out the smaller particles. Another advantage is that the addition of the invention to the filter cartridge discourages the build-up and slough off that commonly occurs as described above. This wrap may be applied to and left on an existing filter to be periodically serviced and or replaced as needed, or simply positioned prior to servicing the filter to retain the accumulation of the filter during removal. In regards to the last mentioned method of use the sleeve or wrap may be fabricated from a fine mesh material similar to the material commonly used in the manufacture of the filter element or pleats themselves. When placed over the filter and snugged down the filter may then be disengaged and removed allowing the water to freely drain out of the filter while retaining the debris that has been accumulated. This method may be used along with the loose mesh wrap that is in place during the complete cycle of filtration to further enhance functionality. Most importantly the invention may quickly and easily be removed to thoroughly clean the filter cartridge as recommended by manufacturers of the same.

### SUMMARY OF INVENTION

A principal object of the invention is to increase the efficiency of a cartridge type filter by the addition of an outer covering of filter media that is capable of adding to the functionality of the filter.

Another principal object of the invention is to increase efficiency of a filter cartridge through the addition of an outer covering of material that will extend the period between necessary maintenance of the filter.

Another principal object of the invention is to provide a product with all the advantages described above that may be quickly placed on and removed from an existing filter. Another object is to provide a means of encapsulating a filter cartridge while in place prior to removing the filter for servicing so as to retain the debris captured by the filter.

An additional object is to provide a simple and easy way to place and secure a sleeve or wrap made up of a fine mesh filter media over a filter while in place in the filter reservoir whereby simplifying the process of removing the filter to service and at the same time retaining the buildup of debris on the filter.

An additional object of the invention is to enhance the efficiency of the filter cartridge through the addition of a sleeve or wrap that covers the pleats of the filter with a nonwoven scour pad like material that will entangle hair and debris with out impeding flow through whereby allowing the pleats of the filter to filter out the smaller particles.

An additional object of the invention is to enhance the efficiency of the filter cartridge through the addition of a sleeve or wrap as described above and with the addition of oil absorption qualities of the filter media used to manufacture the wrap.

An additional object of the invention is to enhance the efficiency of the filter cartridge through the addition of a sleeve or wrap as described above and with the additional functionality possible through the many combinations of elements commonly used in the composition of nonwoven filtration media.

A further object of the invention is to provide a method to tighten the sleeve or cylinder once in place by twisting a rigid strip that runs the length of the device effectively placing a fold in the material and reducing the diameter of the cylinder a premeasured amount to match the outside diameter of the filter.

Further objects will appear as the description proceeds.

To the accomplishment of the above and related objects, this invention may be embodied in the form illustrated in the accompanying drawings, however the drawings are illustrative only, and changes may be made in the specific construction illustrated and described within the scope of the applied claims.

### BRIEF DESCRIPTION OF DRAWINGS

FIG. 1 is a front view of a filter wrap blanket of nonwoven filter media which is placed over a typical cartridge type filter and with one corner turned back to reveal the pleats of the filter. Also visible in this illustration is the hook strip element which will entangle with the loop composition of the nonwoven filter media to secure it in place over the filter cartridge.

FIG. 2 is a front view of a filter wrap cylinder of filtration media with a rigid strip running vertically up and down the the length of the cylinder and with a ring or handle placed at the top for twisting the strip . This cylinder is shown being placed down over a cartridge type filter with the pleats of the filter visible.

FIG. 3 is a three step, closeup view denoted with the capitol letters A, B and C, looking down from above at the cylinder placed over the cartridge filter and illustrating the function of placing a fold in the wall of the cylinder by twisting the rigid strip whereby reducing the diameter of the cylinder effectively snugging the cylinder to the filter.

### DETAILED DESCRIPTION OF THE PREFERRED EMBODIMENTS

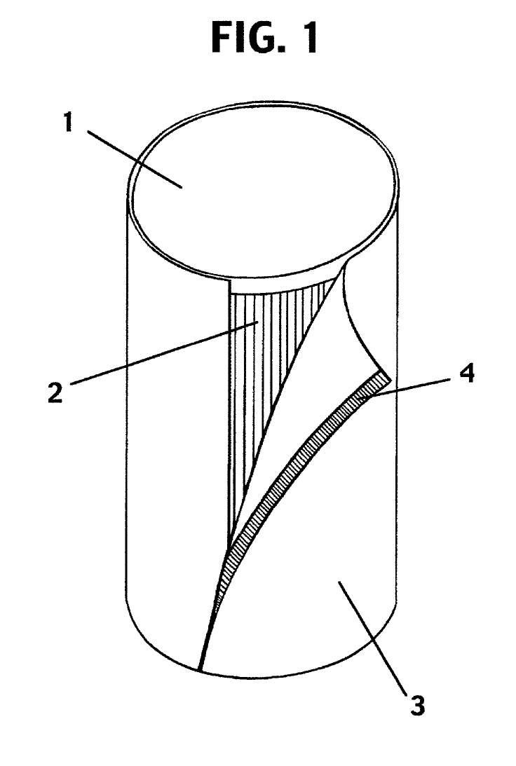

FIG. 1 shows a filter cartridge 1, covered by a filter wrap blanket 3, with the top corner turned back to reveal the pleats 2, of the filter 1. Also revealed is the hook strip 4, that runs along one edge of the wrap 3, which will engage the loop like composition of the wrap 3, securing it around the filter 1. In this way the filter wrap 3, may quickly and easily be secured or removed from the filter cartridge 1.

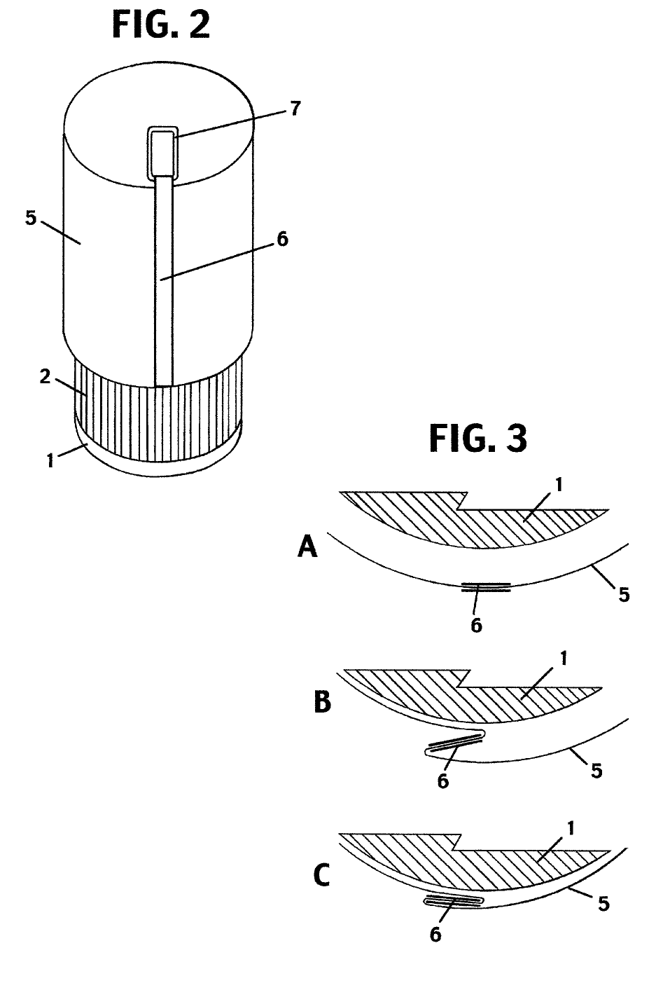

FIG. 2 shows a filter wrap cylinder 5, with a rigid strip 6, of plastic or metal running up the length of the cylinder 5, with a twist ring 7, attached to the top of the strip 6. In this view the cylinder 5, is shown placed over a filter cartridge 1, with the pleats 2, of the filter 1, visible.

FIG. 3 shows a top view of a filter wrap cylinder 5, in place over a filter cartridge 1. In the first illustration A, the rigid strip 6, is flat with the cylinder 5, making the diameter much larger than the diameter of the filter 1. The second illustration B, shows the rigid strip 6, in a partially twisted position whereby reducing the diameter of the cylinder 5. The third illustration C, shows the rigid strip 6, twisted a full ninety degrees lying flat against the cylinder 5, placing a fold in the wall of the cylinder 5, reducing the diameter to fit snug around the filter cartridge 1.

What is claimed is:

1. A covering that fits over a cartridge type filter to enhance the performance and functionality of the filter cartridge.
A covering such as described in claim 1 wherein the covering is a wrap that is placed around the filter cartridge then fastened snugly
A covering such as described in claim 1, wherein the covering is a cylindrical sleeve that fits over a filter cartridge.

2. A covering as described in claim 1, wherein the covering is a cylindrical sleeve with an inside diameter that is significantly larger than the outside dimension of the filter cartridge to facilitate easy placement, the diameter of the cylinder is then reduced once placed over the filter cartridge by placing a fold in the wall of the cylinder by means of twisting a narrow rigid strip of metal or plastic that runs the length of the cylinder.
A covering that fits over a cartridge type filter such as described in claim 2, designed to retain the accumulation of the filter during removal.
A covering such as described in claim 2, wherein the covering is made up of a nonporous but flexible material.
A covering such as described in claim 2, wherein the covering is made up of a porous fabric such as that which is commonly used in the manufacture of filters.

3. A covering as described in claims 1 and 2, above that adds functionality to a cartridge type filter based on the composition of the nonwoven material of the covering.
A covering such as described in claim 3, with the functionality of oil absorption incorporated into the composition of the cover.
A covering such as described in claim 3, with the functionality of carbon incorporated into the composition of the cover.
A covering such as described in claim 3, with the functionality of silver incorporated into the composition of the cover.
A covering such as described in claim 3, with the functionality of ion exchange agents incorporated into the composition of the cover.
